(19) United States
(12) Patent Application Publication
(10) Pub. No.: US 2007/0120893 A1
(43) Pub. Date: May 31, 2007

(54) MICROINJECTORS AND TEMPERATURE INSPECTION METHODS THEREOF

(75) Inventor: Chung Cheng Chou, Taoyuan County (TW)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/563,128

(22) Filed: Nov. 24, 2006

(30) Foreign Application Priority Data
Nov. 30, 2005 (TW) 094142045

(51) Int. Cl. B41J 2/05

(52) U.S. Cl. 347/61

(57) ABSTRACT

Microinjectors are provided. A microinjector includes a substrate, a manifold formed by the substrate, and a plurality of jet units. The jet unit comprises a nozzle plate disposed on the substrate, a chamber formed between the substrate and the nozzle plate, a channel connecting the chamber and the manifold, a nozzle formed on the nozzle plate, a heater disposed on an outer surface of the nozzle plate and adjacent to the nozzle, and a temperature sensor disposed on the outer surface of the nozzle plate. The heater heats the chamber to eject liquid through the nozzle. The sensor is located substantially at the center of the channel for temperature detection.

### BACKGROUND OF THE INVENTION

1. Field of the Invention

The invention relates in general to microinjectors and in particular to microinjectors capable of temperature detection.

2. Description of the Related Art

Microinjection technology has been widely applied to inkjet printers, with two methodologies being thermal bubble and piezoelectric actuations. In thermal actuated inkjet printers, temperature measurement and control are important to facilitate high printing quality and longevity of use.

U.S. Pat. No. 6,357,863 discloses an inkjet print head chip comprising a column of ink heating resistors corresponding to a nozzle array, although precise temperature measurement of each nozzle can be difficult owing to crowding on the chip. U.S. Pat. No. 6,382,773 discloses an inkjet print head comprising a temperature-sensing layer below a heating element. However, the temperature-sensing layer can reduce flatness of the heating area and adversely influence efficiency thereof.

### BRIEF SUMMARY OF THE INVENTION

Microinjectors are provided. A microinjector includes a substrate, a manifold formed by the substrate, and a plurality of jet units. Each jet unit comprises a nozzle plate disposed on the substrate, a chamber formed between the substrate and the nozzle plate, a channel connecting the chamber and the manifold, a nozzle formed on the nozzle plate, a heater disposed on an outer surface of the nozzle plate and adjacent to the nozzle, and a temperature sensor disposed on the outer surface of the nozzle plate. The heater heats the chamber to eject liquid through the nozzle. The sensor is located substantially at the center of the channel for temperature detection.

### BRIEF DESCRIPTION OF THE DRAWINGS

The invention can be more fully understood by reading the subsequent detailed description and examples with references made to the accompanying drawings, wherein:

FIG. 1 is a sectional view of an embodiment of a microinjector;

FIG. 2 is a perspective diagram of two adjacent jet units of a microinjector;

FIG. 3 is a perspective diagram of a plurality of sensors S1˜S19 disposed in a region Ni;

FIG. 4 is a perspective diagram of a plurality of sensors S1˜S19 distributed in N regions N1˜N16;

FIG. 5 is a perspective diagram of another embodiment of a plurality of sensors S1˜S19 distributed in N regions N1˜N16; and

FIG. 6 is a perspective diagram of a temperature inspection method of a microinjector.

### DETAILED DESCRIPTION OF THE INVENTION

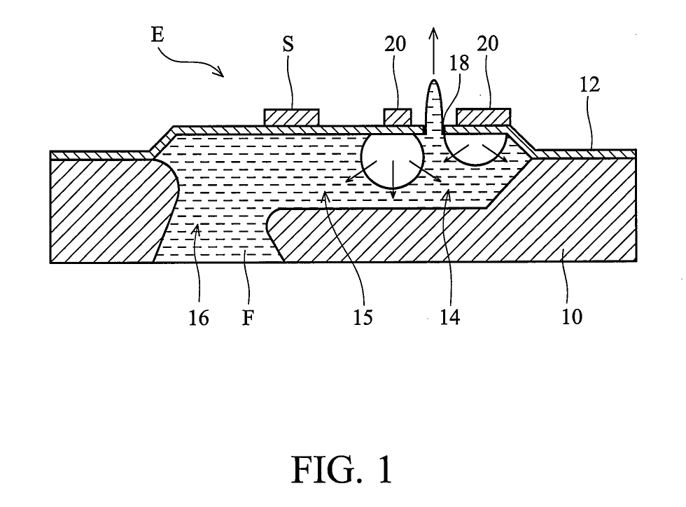

Referring to FIG. 1, an embodiment of a microinjector, such as a monolithic inkjet chip, primarily comprises a substrate 10, a manifold 16 formed by the substrate 10, and a plurality of jet units E. Each jet unit E comprises a nozzle plate 12, a nozzle 18 formed on the nozzle plate 12, a chamber 14 formed between the substrate 10 and the nozzle plate 12, a channel 15 communicating the chamber 14 and the manifold 16, and two heaters 20 disposed on an outer surface of the nozzle plate 12, adjacent to the nozzle 18. As shown in FIG. 1, fluid F is ejected through the nozzle 18 by thermal bubbles generated by the heaters 20. Specifically, some jet units E further comprise a temperature sensor S on the outer surface of the nozzle plate 12, such as a thermal resistor. The sensor S is located above the channel 15, providing temperature measurement without interfering with fluid F and heaters 20.

When the fluid F is ejected from the chamber 14 without timely replenishment, the heaters 20 can rapidly transfer heat through the nozzle layer 12 and cause empty burning of the chamber 14. In this embodiment, the sensor S monitors and detects abnormal high temperature of the jet unit E, preventing empty burning of the chamber 14.

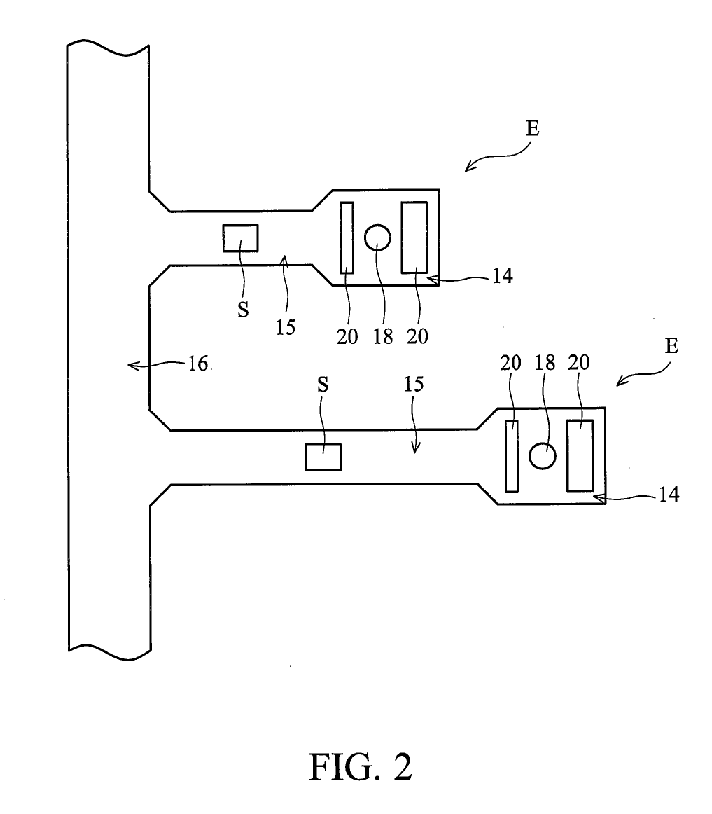

Referring to FIG. 2, the manifold 16 and the chambers 14 of any two adjacent jet units E are connected via the channels 15 in different lengths. Here, the sensors S are respectively disposed in the middle of the channels 15, to detect temperature of the jet units E. When the two chambers 14 are heated by the heaters 20 for a predetermined period, the temperature variation ΔTa and ΔTb are measured by the sensors S on the longer and shorter channels 15 respectively, wherein ΔTa<ΔTb. In this embodiment, the microinjector includes M jet units E provided with M channels 15 in m different lengths, wherein M>m. Specifically, the m sensors S are disposed on m of the M channels 15 for temperature detection, corresponding to the m different lengths.

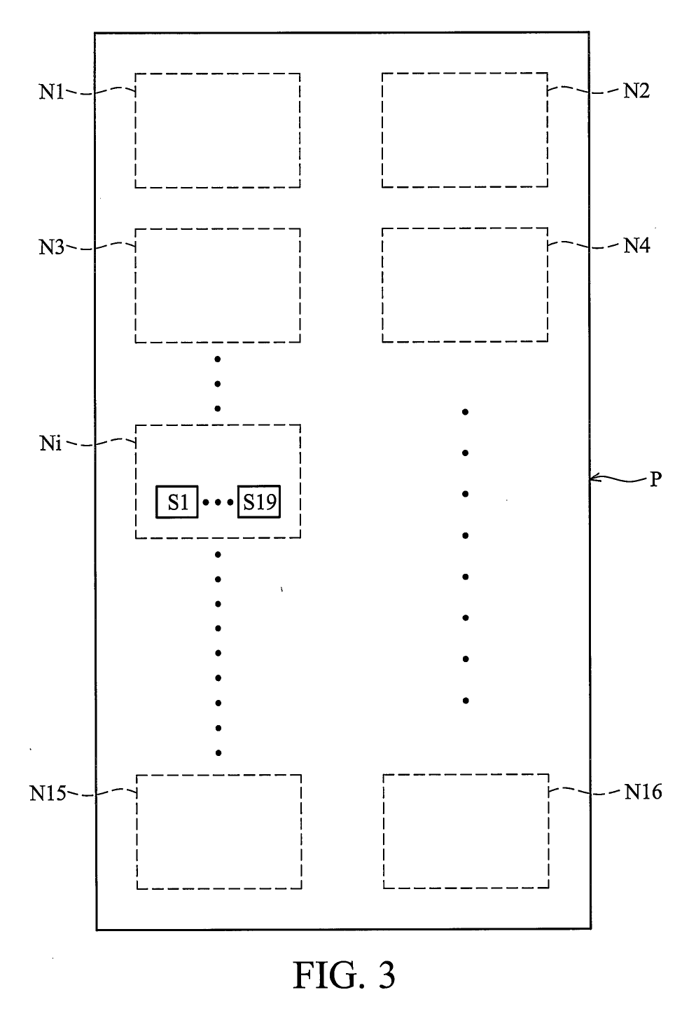

An exemplary embodiment of the microinjector, such as an inkjet chip P shown in FIG. 3, includes 300 jet units E having 300 channels in 19 different lengths (i.e. M=300, m=19). Here, the 300 jet units E are distributed in N regions N1˜N16 (i.e. N=16), wherein each of the regions N1˜N16 has 18 or 19 channels in different lengths (four of the regions N1˜N16 contain only 18 jet units E). The numbers of M, m, and N can be adjusted by demand, wherein M>m≧N. As the channels of the same length have similar temperature behavior, temperature of these channels can be represented by one sensor applied to one thereof, such that data processing and mechanism are simplified.

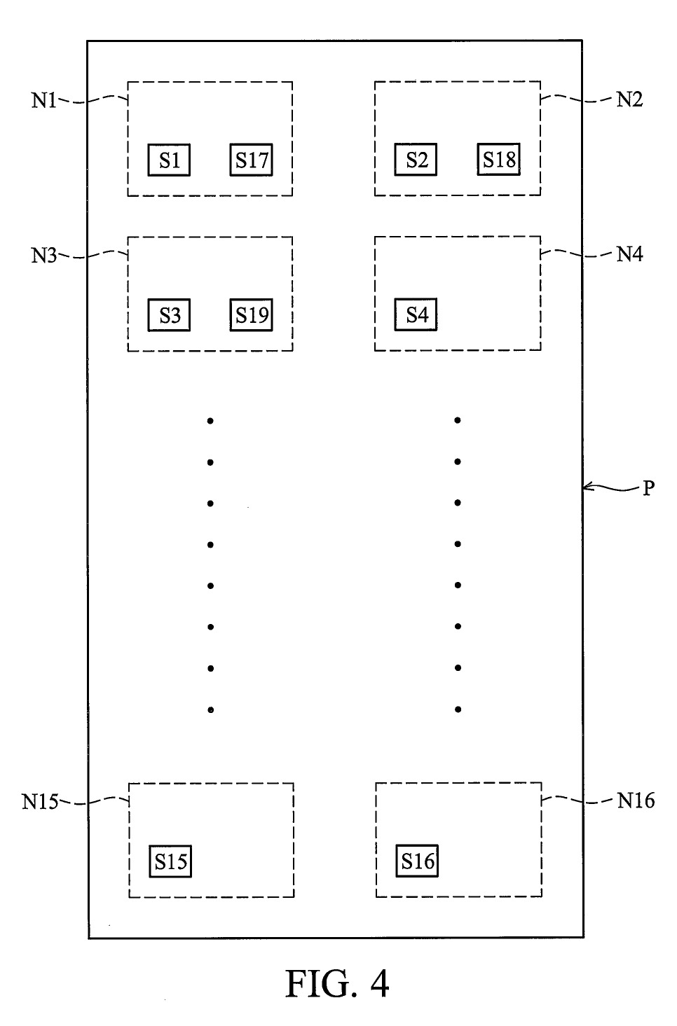

As shown in FIG. 3, the sensors S1˜S19 are disposed in a region Ni among the regions N1˜N16. Due to approximate detection circuit lengths of the sensors S1˜S19 collected in the region Ni, noise and parasitic resistance are prevented, improving measurement accuracy thereof. Referring to FIG. 4, another embodiment provides sensors S1˜S19 averagely distributed among the regions N1˜N16, corresponding to 19 channels of different lengths. Here, since the number of the sensors (m=19) exceeds that of the regions (N=16), each of the regions N1˜N16 has at least one sensor, wherein the three regions N1˜N3 have two sensors, as shown in FIG. 4. In this embodiment, the sensors S1˜S19 not only reflect temperature of the channels in 19 different lengths, but also represent temperature of the different regions N1˜N16.

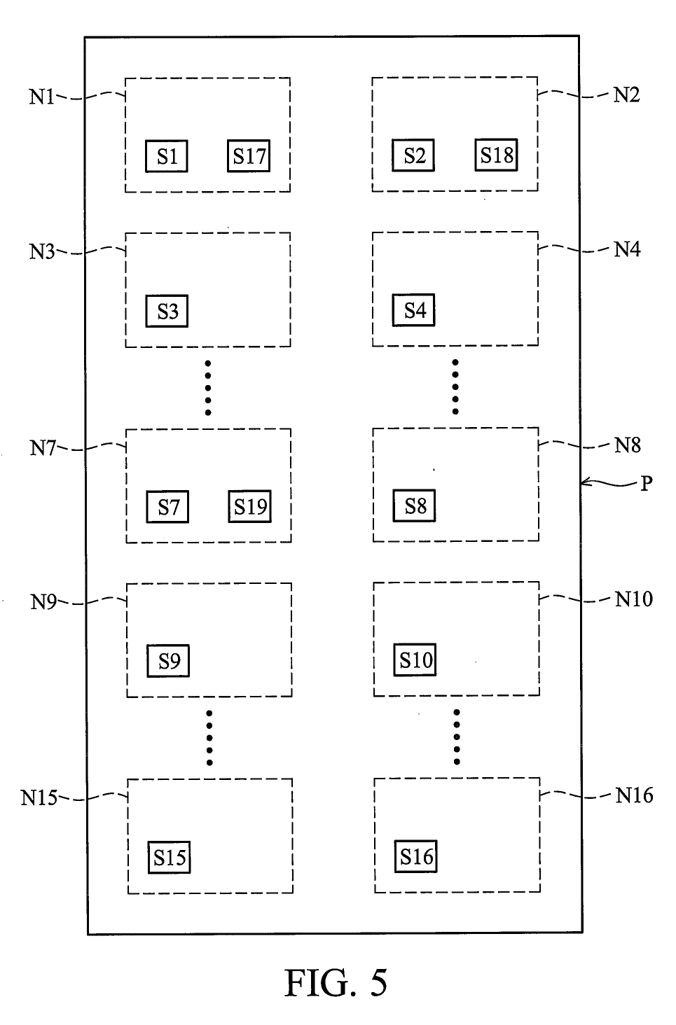

Referring to FIG. 5, another embodiment of the first sensor S1 is disposed in a corner region N1 (or the corner region N2, N15, or N16) farthest from the center of the microinjector, and the last sensor S19 is disposed in a central region N7 (or the central regions N8, N9, or N10) nearest to the center of the microinjector. Here, the sensors S1˜S19 are disposed on the channels corresponding to the 19 different lengths, wherein the sensors S1 and S19 are respectively disposed on the longest and shortest channels thereof.

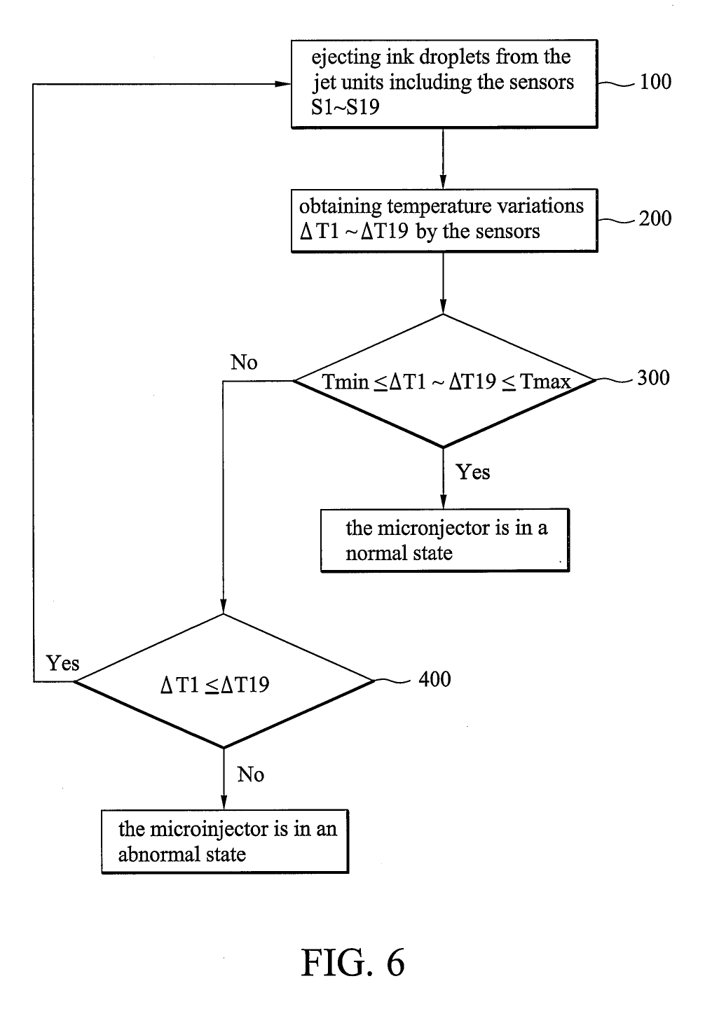

Referring to FIG. 6, the invention further provides a temperature inspection method of the microinjector. The method primarily comprises ejecting ink droplets from the jet units including the sensors S1˜S19 (step 100), obtaining temperature variations ΔT1˜ΔT19 by the sensors S1˜S19 (step 200), and determining whether the temperature variations ΔT1˜ΔT19 are between a minimum temperature Tmin and a maximum temperature Tmax (step 300).

As shown in FIG. 6, the micronjector is in a normal state if Tmin≦ΔT1˜ΔT19≦Tmax. However, if any of the temperature variations ΔT1˜ΔT19 exceeds the predetermined range between Tmin and Tmax, and ΔT1≦ΔT19 (step 400), the step 100 is repeated for the second time detection. Alternatively, if any of ΔT1˜ΔT19 exceeds the range between Tmin and Tmax, and ΔT1>ΔT19 (i.e. temperature variation of the longest channel abnormally exceeds the shortest channel), a detection circuit coupled with the sensors transmits an alarm signal to a processor (not shown), indicating the microinjector is in an abnormal state without timely replenishment. When in the abnormal state, the microinjector (such as the inkjet chip P) is to be replaced immediately. Such phenomenon described above is usually happened when ink volume of cartridge is lesser, and it causes incomplete ink replenishment for chamber with longer channel.

Microinjectors and temperature inspection method thereof are provided according to the embodiments. A number of sensors are disposed in some of the jet units, corresponding to different lengths of the channels, such that data processing and mechanism are simplified. The sensors can monitor and detect temperature variations due to abnormal fluid replenishment, without interference to fluid and the heaters, improving efficiency and life of the microinjector. The invention can be widely applied to inkjet printers, multi-function printers, fuel injection systems, or drug delivery systems.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A microinjector, comprising:
a substrate;
a manifold, formed by the substrate;
a plurality of jet units, each of the jet units comprising:
a nozzle plate, disposed on the substrate;
a chamber, formed between the substrate and the nozzle plate;
a channel, formed between the substrate and the nozzle plate, connecting the chamber and the manifold;
a nozzle, formed on the nozzle plate, connecting the chamber;
a heater, disposed on an outer surface of the nozzle plate and adjacent to the nozzle, heating the chamber to eject liquid through the nozzle; and
a temperature sensor, disposed on the outer surface of the nozzle plate and substantially located at the center of the channel for temperature detection.

2. The microinjector as claimed in claim 1, wherein the channels of the jet units have different lengths.

3. The microinjector as claimed in claim 2, wherein the sensors are coupled to a detection circuit, and when any of the sensors detects an abnormal temperature exceeding a predetermined range and temperature variation of the longest channel exceeding that of the shortest channel, the detection circuit transmits an alarm signal to a processor.

4. The microinjector as claimed in claim 1, wherein the heater generates a thermal bubble in the chamber to eject fluid through the nozzle.

5. The microinjector as claimed in claim 1, wherein the microinjector has a monolithic structure.

6. The microinjector as claimed in claim 1, wherein the temperature sensor comprises a thermal resistor.

7. A microinjector, comprising:
a substrate;
a manifold, formed by the substrate;
M jet units, distributed in N regions, each of the jet units comprising:
a nozzle plate, disposed on the substrate;
a chamber, formed between the substrate and the nozzle plate;
a nozzle, formed on the nozzle plate, connecting the chamber;
a heater, disposed on an outer surface of the nozzle plate and adjacent to the nozzle, heating the chamber to eject liquid through the nozzle;
a channel, formed between the substrate and the nozzle plate, connecting the chamber and the manifold, wherein the M channels of the M jet units have m different lengths (M>m); and
m temperature sensors, respectively disposed on m of the M channels in m different lengths.

8. The microinjector as claimed in claim 7, wherein each of the sensors is disposed on the outer surface of the nozzle plate and located at the center of the channel for temperature detection.

9. The microinjector as claimed in claim 7, wherein the sensors are coupled to a detection circuit, and when any of the sensors detects an abnormal temperature exceeding a predetermined range and temperature variation of the longest channel exceeding that of the shortest channel, the detection circuit transmits an alarm signal to a processor.

10. The microinjector as claimed in claim 9, wherein the longest of the m channels provided with the sensors is located in the farthest region from the center of the microinjector.

11. The microinjector as claimed in claim 10, wherein the shortest of the m channels provided with the sensors is located in the nearest region from the center of the microinjector.

12. The microinjector as claimed in claim 7, wherein the m sensors are distributed in the N regions, wherein m≧N.

13. The microinjector as claimed in claim 7, wherein the m sensors are disposed in one of the N regions.

14. The microinjector as claimed in claim 7, wherein the heater generates a thermal bubble in the chamber to eject fluid through the nozzle.

15. The microinjector as claimed in claim 7, wherein the microinjector has a monolithic structure.

16. The microinjector as claimed in claim 7, wherein the temperature sensor comprises a thermal resistor.

17. A temperature inspection method for a microinjector, wherein the microinjector includes a manifold and M jet units distributed in N regions, and each of the jet units comprises a chamber, a nozzle connecting the chamber, and a channel connecting the chamber and the manifold, wherein the M channels of the M jet units have m different lengths, the method comprising:
(a) applying m sensors to m of the M channels in m different lengths, wherein M>m;
(b) ejecting ink droplets from the m jet units provided with the sensors and obtaining temperature variations thereof by the sensors; and
(c) determining whether the microinjector is in an abnormal state according to the temperature variations obtained by the m sensors.

18. The method as claimed in claim 17, wherein the longest of the m channels provided with the sensors is located in the farthest region from the center of the microinjector.

19. The method as claimed in claim 18, wherein the shortest of the m channels provided with the sensors is located in the nearest region from the center of the microinjector.

20. The method as claimed in claim 19, wherein step (c) comprises transmitting an alarm signal to a processor when any of the temperature variations exceeds a predetermined range.

21. The method as claimed in claim 17, wherein the m sensors are distributed in the N regions, wherein m≧N.

22. The method as claimed in claim 17, wherein the m sensors are disposed in one of the N regions.

23. The method as claimed in claim 17, wherein the microinjector has a monolithic structure.

24. The method as claimed in claim 17, wherein the temperature sensor comprises a thermal resistor.
